(19) United States
(12) Patent Application Publication
(10) Pub. No.: US 2013/0251387 A1
(43) Pub. Date: Sep. 26, 2013

(54) IMAGE FORMING APPARATUS

(71) Applicant: CANON KABUSHIKI KAISHA, Tokyo (JP)

(72) Inventor: Shigeru Tanaka, Tokyo (JP)

(73) Assignee: CANON KABUSHIKI KAISHA, Tokyo (JP)

(21) Appl. No.: 13/834,539

(22) Filed: Mar. 15, 2013

(30) Foreign Application Priority Data
Mar. 21, 2012 (JP) 2012-063880

(51) Int. Cl. G03G 15/00

(52) U.S. Cl. CPC G03G 21/203
USPC 399/44

(57) ABSTRACT

An image forming apparatus includes an image bearing member; a developing device, including a developer carrying member for carrying a developer, for developing a latent image formed on the image bearing member; a humidity sensor for detecting a humidity of the developer in contact with the developer in the developing device; and a controller for controlling an image forming condition on the basis of a detection result of the humidity sensor. The controller is capable of executing an operation in a mode, for correcting the image forming condition, on the basis of a history of information on the humidity detected by the humidity sensor when a drive time of the developing device from start of image formation is less than a predetermined time.

### FIELD OF THE INVENTION AND RELATED ART

The present invention relates to an image forming apparatus in which a developing contrast for image formation is set depending on a humidity of a developer directly detected by a humidity sensor. Specifically, the present invention relates to a control capable of properly setting the developing contrast during actuation of a developing device even when an ambient humidity is largely changed during a stop period of the developing device.

An image forming apparatus in which the developer is, after being stirred in the developing device, carried on a developer carrying member to developer an electrostatic image on an image bearing member into a toner image has been widely used. The type of the developing device includes a one-component developing type using a magnetic toner and a two-component developing type using a magnetic carrier. The developing device has hermeticity to the extent that leaking-out of the toner can be prevented but permits coming and going of outside air through various gaps. For this reason, humidity of the developer is adjusted at the same humidity as an ambient humidity of the developing device in about 20 minutes when the developing device is kept in an operation state and in about 20 hours when the developing device is in a rest (stop) state.

The humidity of the developer has a large influence on a toner charge amount Q/M when the electrostatic image on the image bearing member is developed, and the toner charge amount Q/M has a large influence of a toner amount per unit area of the toner image obtained by developing the electrostatic image at a predetermined developing contrast. For this reason, it is preferable that an average humidity of the developer in the developing device is fed back to a toner image forming condition.

In Japanese Laid-Open Patent Application (JP-A) 2007-65581, a humidity sensor is provided and buried in the developer in the developing device and directly develops the humidity of the developer, and then the developing contrast is adjusted in real time so that the developing contrast becomes lower with a higher humidity of the developer.

In JP-A 2011-248154, an environment sensor for detecting temperature and humidity of ambient air of the developing device is provided and in a stop period of the developing device, a history of ambient humidity detected by the environment sensor is recorded. Then, during actuation of the developing device, current humidity of the developer estimated depending on the recorded history of the ambient humidity change, and then the developing contrast is set.

In control of JP-A 2011-248154, the developer humidity is not detected directly and therefore is some cases, a difference between the estimated developer humidity and actual developer humidity is generated and thus the developing contrast becomes improper. On the other hand, in control of JP-A 2007-65581, the developer humidity is directly detected by using the humidity sensor, so that the developing contrast can be set in real time with high reproducibility depending on the actual humidity of the developer.

However, in the control of JP-A 2007-65581, in a period in which several tens of seconds are not elapsed from the actuation of the developing device, the developing contrast cannot be properly set and compared with an output image after a lapse of several tens of seconds, it was turned out that an image density reproducibility is lowered.

During a stop period of the developing device, the developer is humidity-adjusted from its surface contacting the air toward its deep position while taking time. The developer in the developing device has the humidity closer to the ambient humidity at a position closer to its surface and has a larger humidity difference from the ambient humidity at a deeper position thereof. Therefore, when the developing device is actuated after the stop period, in a process in which the developer at the surface and the developer at the deep position are mixed with each other, the developer humidity detected by the humidity sensor is abruptly changed. For this reason, a difference is generated between the developer humidity detected by the humidity sensor and an average humidity of the developer as a whole, so that the developing contrast became improper.

Here, when the developing device is actuated and then idled for about 30 seconds, the developer humidity detected by the humidity sensor and the average humidity of the developer as a whole coincide with each other and therefore even when the developer humidity detected by the humidity sensor is used as it is, it is possible to properly set the developing contrast. However, the idling of the developing device is not preferable from the viewpoints of deterioration of the developer, electric power saving and productivity of the image forming apparatus.

### SUMMARY OF THE INVENTION

A principal object of the present invention is to provide an image forming apparatus capable of properly setting a developing contrast after actuation on the basis of humidity of a developer detected by a humidity sensor even when an idling time of a developing device is suppressed in the case where the humidity of the developer is largely changed in a stop period.

According to an aspect of the present invention, there is provided an image forming apparatus comprising: an image bearing member; a developing device, including a developer carrying member for carrying a developer, for developing a latent image formed on the image bearing member; a humidity sensor for detecting a humidity of the developer in contact with the developer in the developing device; and a controller for controlling an image forming condition on the basis of a detection result of the humidity sensor, wherein the controller is capable of executing an operation in a mode, for correcting the image forming condition, on the basis of a history of information on the humidity detected by the humidity sensor when a drive time of the developing device from start of image formation is less than a predetermined time.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of an image forming portion.

FIG. 3 is an illustration of a structure of a developing device in horizontal cross section.

FIG. 4 is an illustration of a structure of a developer temperature/humidity sensor.

FIG. 5 is a circuit block diagram of the developer temperature/humidity sensor.

FIG. 6 is a block diagram of a control system of the image forming apparatus.

FIG. 7 is an illustration of a simulation of a humidity adjustment phenomenon of a developer with ambient humidity change.

FIG. 8 is a graph showing a relationship between a depth of the developer and a humidity adjustment time in the simulation.

FIG. 9 is an illustration of a measurement result of a correction value of detected humidity.

FIG. 10 is an illustration of a table of the correction value of the detected humidity.

FIG. 11 is an illustration of a change in detected humidity of the developer temperature/humidity sensor during actuation of the developing device.

FIG. 12 is a flow chart of control in Embodiment 1.

FIG. 13 is an illustration of setting of a developing contrast in Embodiment 1.

FIG. 14 is an illustration of a humidity adjustment curve of the developer after stop of the developing device.

FIG. 15 is an illustration of a humidity correction value at each time after the stop of the developing device.

FIG. 16 is a flow chart of control in Embodiment 3.

FIG. 17 is a flow chart of control in Embodiment 4.

### DESCRIPTION OF THE PREFERRED EMBODIMENTS

Hereinbelow, embodiments of the present invention will be described specifically with reference to the drawings. The present invention can also be carried out in other embodiments in which a part or all of constitutions of the following embodiments are replaced with alternative constitutions so long humidity of a developer after start of stirring is estimated on the basis of the developer humidity measured in a developing device.

Therefore, the present invention can also be carried out in the image forming apparatus of not only a two-component developing type but also a one-component developing type. Further, the present invention can also be carried out in the image forming apparatus of any of types such as a tandem type, one drum type, an intermediary transfer type, a recording material conveyance type and a sheet-fed transfer type. An image bearing member is not limited to an organic photosensitive member but may also be an inorganic photosensitive member such as an amorphous silicon photosensitive member. The image bearing member is not limited to a photosensitive drum but may also be a belt-like photosensitive member. It is also possible to arbitrarily select types of charging, development, transfer, cleaning and fixing.

In the following embodiments, only a major part of the image forming apparatus relating to formation and transfer of the toner image will be described but the present invention can be carried out in various fields of image forming apparatuses such as printers various printing machines, copying machines, facsimile machines, and multi-function machines.

### <Image Forming Apparatus>

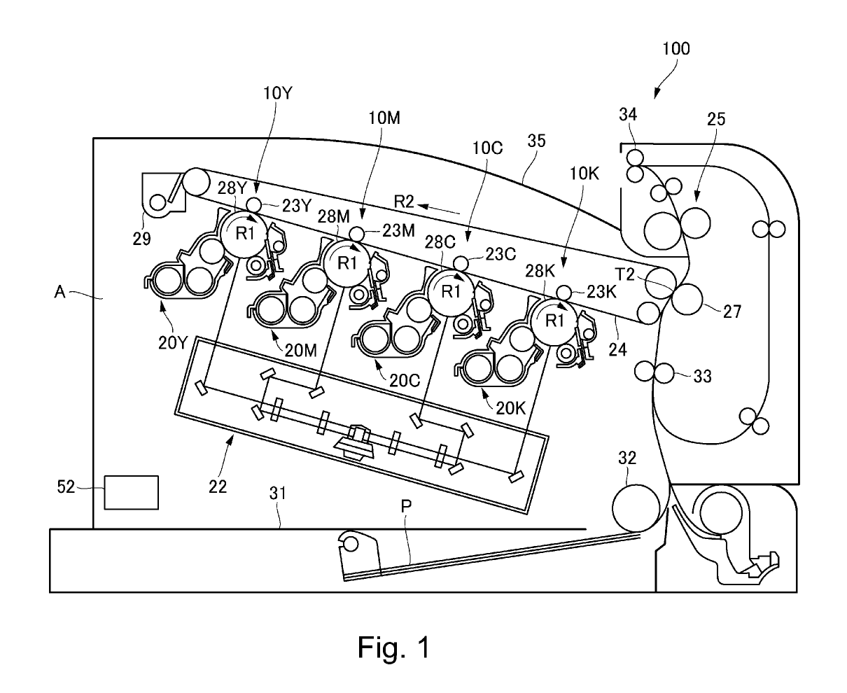

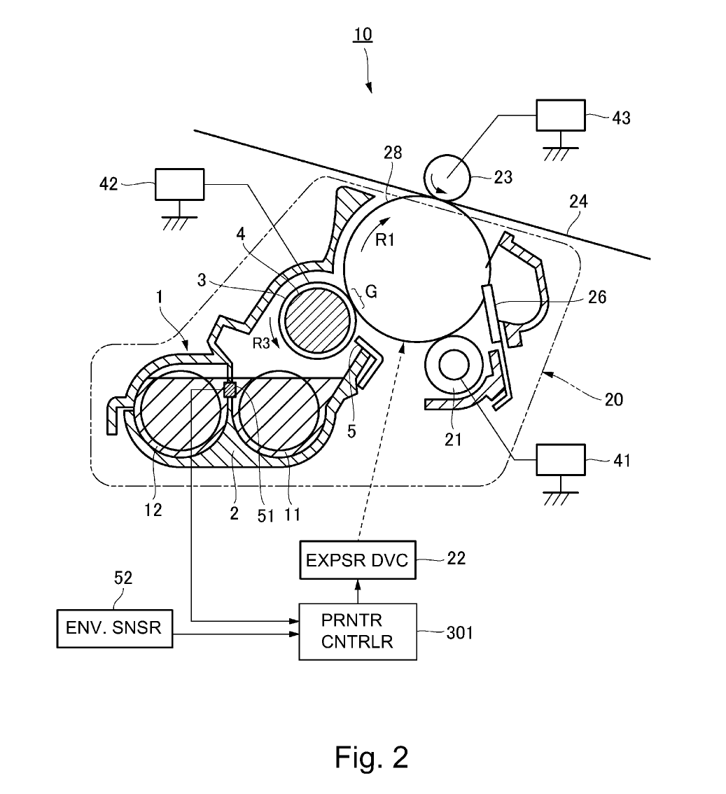

FIG. 1 is an illustration of a structure of an image forming apparatus 100. FIG. 2 is an illustration of a structure of an image forming portion 10. As shown in FIG. 1, the image forming apparatus 100 is an intermediary transfer type full-color printer of the tandem type (“LBP5900”, mfd. by Canon K.K.). The image forming apparatus 100 is prepared by arranging drum cartridges 20Y, 20M, 20C and 20K for yellow, magenta, cyan and black, respectively, along a lower (downward) surface of an intermediary transfer belt 24 to constitute image forming portions 10Y, 10M, 10C and 10K for the respective colors. Each of the drum cartridges 20Y, 20M, 20C and 20K is prepared by assembling a photosensitive drum, a developing device and the like into a unit for the associated color in a replaceable manner.

At the image forming portion 10Y, a yellow toner image is formed on a photosensitive drum 28Y and then is transferred onto the intermediary transfer belt 24. At the image forming portion 10M, a magenta toner image is formed on a photosensitive drum 28M and then is transferred onto the intermediary transfer belt 24. At the image forming portions 10C and 10K, a cyan toner image and a black toner image are formed on photosensitive drums 28C and 28K, respectively, and then are transferred onto the intermediary transfer belt 24.

The four color toner images transferred on the intermediary transfer belt 24 are conveyed to a secondary transfer portion T2, where the toner images are secondary-transferred onto a recording material P.

The recording material position pulled out from a recording material cassette 31 is separated one by one and then is fed to a registration roller 33. The registration roller 33 sends the recording material P to the secondary transfer portion T2 by timing the recording material P to the toner images on the intermediary transfer belt 24. The recording material P on which the toner images are transferred is heated and pressed by a fixing device 25, so that the toner images are fixed on a surface of the recording material P. Thereafter, the recording material P is discharged on to a discharge tray 35.

The image forming portions 10Y, 10M, 10C and 10K have the substantially same constitution except that the colors of toners used in the respective developing devices are different from each other. In the following description, with reference to FIG. 2, constituent members (portions) are represented by reference numerals (symbols) from which suffixes Y, M, C and K for representing differentiation among the constituent members (portions) for the image forming portions 10Y, 10M, 10C and 10K are omitted, and redundant description relating to the image forming portion will be omitted.

As shown in FIG. 2, at the image forming portion 10, around the photosensitive drum 28, a corona charger 21, an exposure device 22, a developing device 1, a primary transfer roller 23 and a drum cleaning device 26 are disposed. The photosensitive drum 28 is prepared by forming a negative chargeable photosensitive layer on an outer peripheral surface of an aluminum cylinder, and is rotated in an arrow R1 direction at a predetermined process speed (peripheral speed).

The charging roller 2 is supplied, from a charging power source 41, with an oscillating voltage in the form of a DC voltage biased with an AC voltage to electrically charges the surface of the photosensitive drum 28 uniformly to a negative-polarity dark portion potential VD. The exposure device 22 writes (forms) an electrostatic image for an image on the charged surface of the photosensitive drum 28 by scanning of the charged surface through a rotation mirror with a laser beam. When the surface of the photosensitive drum 28 charged to the dark portion potential VD is exposed to light, a positive charge transporting material generated from a functional layer of the photosensitive layer cancels the negative electric charges on the surface of the photosensitive drum 28, so that the surface potential is lowered to a light portion potential VL.

The developing device 1 develops the electrostatic image to form the toner image on the surface of the photosensitive drum 28. The primary transfer roller 23 urges an inner surface of the intermediary transfer belt 24 to form a toner image transfer portion between the photosensitive drum 28 and the intermediary transfer belt 24. By applying, from a transfer power source 43, a DC voltage of a polarity to the primary transfer roller 23, the negatively charged toner image carried on the photosensitive drum 28 is primary-transferred onto the intermediary transfer belt 24. The drum cleaning device 26 collects a transfer residual toner remaining on the photosensitive drum 28 without being transferred onto the recording material P.

### <Developing Device>

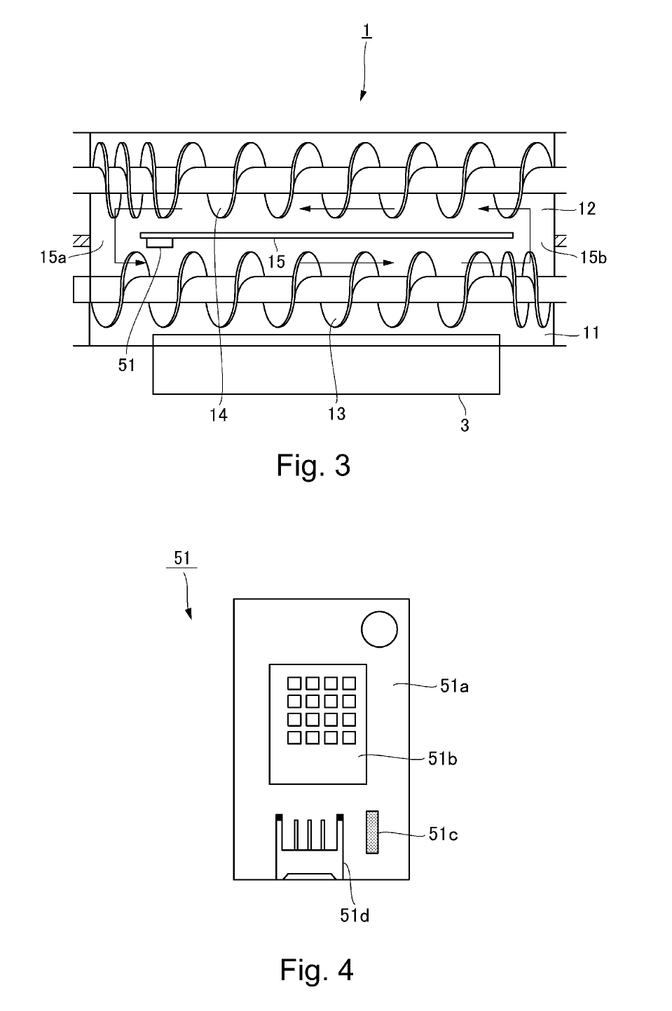

FIG. 3 is an illustration of a structure of the developing device 1 in horizontal cross section. As shown in FIG. 2, the developing device 1 accommodates the developer (two-component developer) in a developing container 2. The developer is prepared by mixing a negatively chargeable toner (non-magnetic toner) with a positively chargeable carrier (magnetic carrier). A toner content (weight ratio of the toner) contained in the developer in an initial state is 7%.

The toner is prepared by kneading a composition including a polyester binder resin as a main component, a colorant, a wax component and the like and then by pulverizing and classifying the kneaded composition to obtain powder of about 7 μm in volume-average particle size. As the binder resin for the toner, it is also possible to employ a styrene-acrylic resin material. As a manufacturing method of the toner, other than the pulverization method, a polymerization method can be used. The carrier is particles, of 50 μm in volume-average particle size, formed by surface-coating a ferrite core with a silicone resin material. As the carrier, it is also possible to use particles prepared by mixing magnetic powder with a phenolic resin material and then by forming the mixture into a spherical shape.

At a portion where the developing container 2 opposes the photosensitive drum 28, an opening is provided, and a developing sleeve 3 is rotatably provided while being partly exposed to the outside through the opening. The developing sleeve 3 is constituted by an aluminum pipe which is a non-magnetic material. The developing sleeve 3 opposes the photosensitive drum 28 in a developing region G with a minimum distance. Inside the developing sleeve 3, a magnet 4 is provided in a non-rotational state. The magnet 4 has a plurality of magnetic poles along its outer peripheral surface. A layer thickness regulating blade 5 is provided upstream of the developing region G with respect to a rotational direction of the developing sleeve 3 so as to oppose one of the magnetic poles of the magnet 4. The layer thickness regulating blade 5 regulates a layer thickness of the developer in an erected chain state in cooperation with the magnet 4.

During a developing operation, the developing sleeve 3 rotates in an arrow R3 direction and holds, at its surface, the developer in the developing container 2 by a magnetic force of the magnet 4. The layer thickness of the developer is regulated by the layer thickness regulating blade 5, and the developer is nipped and conveyed in the developing region G. The developer carried by the developing sleeve 3 is erected in the developing region G in response to one of the magnetic poles of the magnet 4 to form a magnetic brush. In a state in which the magnetic brush of the developer is contacted to the surface of the photosensitive drum 28, a developing power source 42 applies, to the developing sleeve 3, an oscillating voltage in the form of a DC voltage Vdc biased with an AC voltage Vac. As a result, by the action of an electric field formed between the photosensitive drum 28 and the developing sleeve 3, the toner is moved to the photosensitive drum 28. The toner in the developer is moved to the portion of the light portion potential VL where the surface of the develop 28 is exposed to light, so that the electrostatic image is reversely developed into the toner image. The developer on the portion 28 after the electrostatic image is developed is conveyed with rotation of the developing sleeve 3 and then is collected in a developing chamber 11 of the developing container 2.

A negative DC voltage applied to the developing sleeve 3 is Vdc. The toner is not moved to a region of the negative dark portion potential VD on the photosensitive drum 28 but is moved to a region of the negative light portion potential VL, on the photosensitive drum 28, which is positive relative to Vdc. In this case, a developing contrast Vcont which dominates a toner deposition amount and a fog-removing potential Vback for suppressing deposition of the toner are defined as follows.

Vcont=|Vdc−VL|

Vback=|VD−Vdc|

As shown in FIG. 3, the developing container 2 is divided into the developing chamber 11 and a stirring chamber 12. The developing chamber 11 and the stirring chamber 12 communicate with each other through communicating portions 15a and 15b provided at longitudinal ends of a partition wall 15, thus forming a circulating path of the developer. The developing chamber 11 is provided in parallel to the developing sleeve 3, and in the developing chamber 11, a developing screw 13 is provided. The stirring chamber 12 is provided in parallel to the developing chamber 11 and in the stirring chamber 12, a stirring screw 14 is provided.

The developing sleeve 3, the developing screw 13 and the stirring screw 14 are connection-driven by an unshown gear train and receive a driving force from an unshown developing device driving gear, thus being rotated integrally. The developing screw 13 and the stirring screw 14 feed the developer in opposite directions to circulate the developer between the developing chamber 11 and the stirring chamber 12. In a process in which the developer is fed and stirred by the rotation of the developing screw 13 and the stirring screw 14, the toner and the carrier are triboelectrically charged, so that the toner is negatively charged and the carrier is positively charged.

### <Developer Temperature/Humidity Sensor>

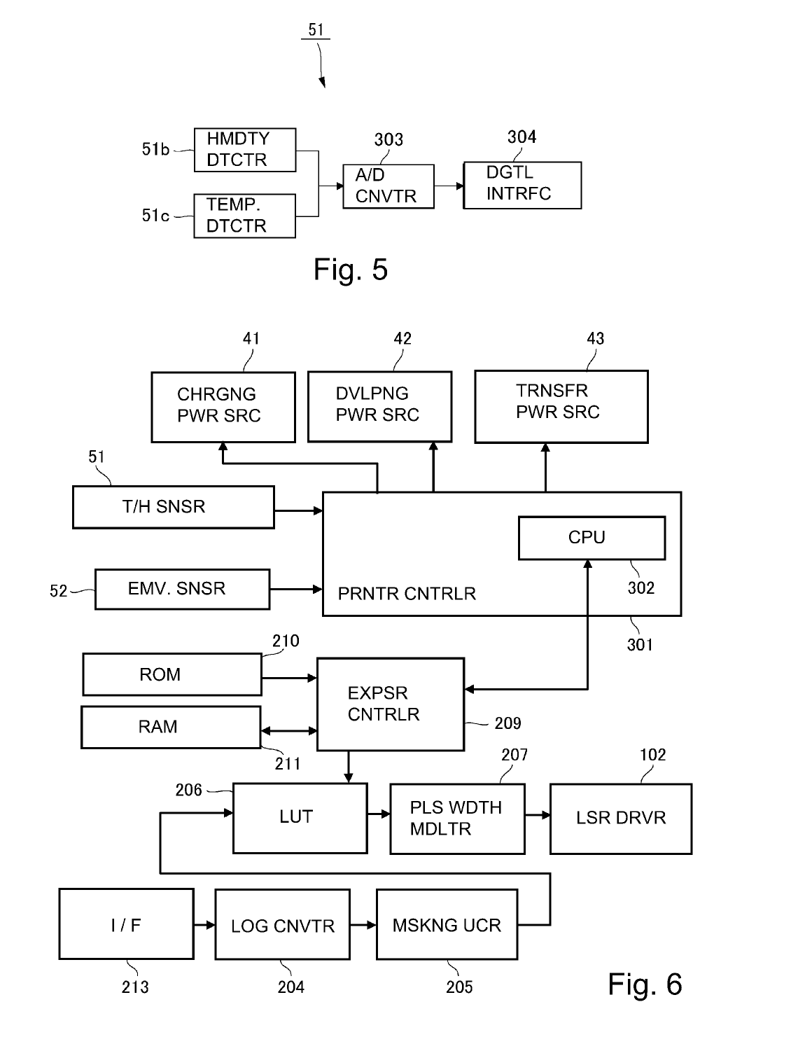

FIG. 4 is an illustration of a structure of a developer temperature/humidity sensor. FIG. 5 is a circuit blocked diagram of the developer temperature/humidity sensor.

In the image forming apparatus of an electrophotographic type, the toner charge amount Q/M of the developer is liable to be influenced by an environmental condition of the developing device, i.e., ambient temperature and humidity of the image forming apparatus. When environmental (ambient) humidity of the image forming apparatus is changed, a water content of the developer in the developing device is changed and therefore in the image forming apparatus, the developer temperature/humidity sensor is provided in the developing device and then a toner image forming condition is changed on the basis of a detection result of the temperature and the humidity.

As shown in FIG. 2, a developer temperature/humidity sensor 51 is attached inside the developer in a stop state, indicated by hatch lines, at a height where the developer temperature/humidity sensor 51 is shallowly buried in the developer. The developer temperature/humidity sensor 51 contacts the developer in the developing container 2 and directly measures the humidity of the developer. A printer controller 301 estimates a change in toner charge amount Q/M on the basis of humidity information outputted by the developer temperature/humidity sensor 51 and reflects the change in the toner image forming condition, thus stabilizing a density and color of an output image.

As shown in FIG. 3, the developer temperature/humidity sensor 51 is disposed at an end portion of the partition wall 15 close to the communicating portion 15a where the developer is delivered from the stirring chamber 12 to the developing chamber 11.

As shown in FIG. 4, the developer temperature/humidity sensor 41 is prepared by mounting, on a common mounting member 51a, a humidity detecting element 51b using a sensing element of an electrostatic capacity polymer and a temperature detecting element 51c using a band-gap member sensor. The humidity detecting element 51b is a capacitor in which a hygroscopic electrostatic capacity polymer as a dielectric material is inserted. The humidity detecting elements 51b detects the humidity by using a phenomenon that the water content absorbed by the electrostatic capacity polymer is changed with the change in humidity with the result that the electrostatic capacity of the capacitor is changed. The temperature detecting element 51c calculates the temperature from a resistance value of a thermistor changed in resistance value linearly with respect to the temperature. The detection information of the developer temperature/humidity sensor 51 is outputted through a connector 51d.

As shown in FIG. 5, as the developer temperature/humidity sensor 51, a temperature/humidity sensor (“SHT1X” mfd. by Sensirion Co., Ltd.) was used. Each of the humidity detecting element 51b and the temperature detecting element 51c is coupled with a 14-bit A/D converter 303 and sends data to the printer controller (301 in FIG. 2) through a digital interface 304.

### <Control System of Image Forming Apparatus>

FIG. 6 is a block diagram of the image forming apparatus. As shown in FIG. 6 with reference to FIG. 2, to the printer controller 301, the developer temperature/humidity sensor 51, an environment sensor 52, the charging power source 41, the developing power source 42 and the transfer power source 43 are connected. The printer controller 301 effects integrated control of an operation of a main assembly of the image forming apparatus 100. The printer controller 301 contacts various operations of the image forming apparatus 100. The printer controller 301 operates so that a CPU 302 functions as a base unit, and cooperates with an exposure controller 209 in an image processing unit side via an interface. The exposure controller 209 contacts a laser driver 102 on the basis of a pulse signal of a pulse width modulation portion 207 to drive an exposure device 22, so that the surface of the photosensitive drum 28 is irradiated with the laser beam.

Color image data in the form of RGB image data from an external device such as an original reader (flat head scanner) or an external computer (information processing apparatus) are inputted into an external input interface (I/F) 213, as desired. An LOG converter 204 converts luminance (brightness) data of the inputted RGB image data into density data of respective colors or yellow (Y), magenta (M) and cyan (C) (YMC image data) on the basis of a look-up table (LUT) stored in ROM 210. A masking/UCR portion 205 extracts component data for black (K) and subjects YMCK image data to matrix operation in order to correct image density of each of colors. A look-up table portion (LUT portion) 206 subjects the inputted YMCK image data to density correction every color by using γ look-up table so as to match an ideal gradation characteristic of the printer portion. The γ0 look-up table is prepared on the basis of data developed on RAM 211 and contents thereof are set by the exposure controller 209. A pulse width modulating portion 207 outputs a pulse signal with a pulse width corresponding to a level of the image data (image signal) inputted from the LUT portion 206.

### <Humidity Adjustment Non-Uniformity of Developer>

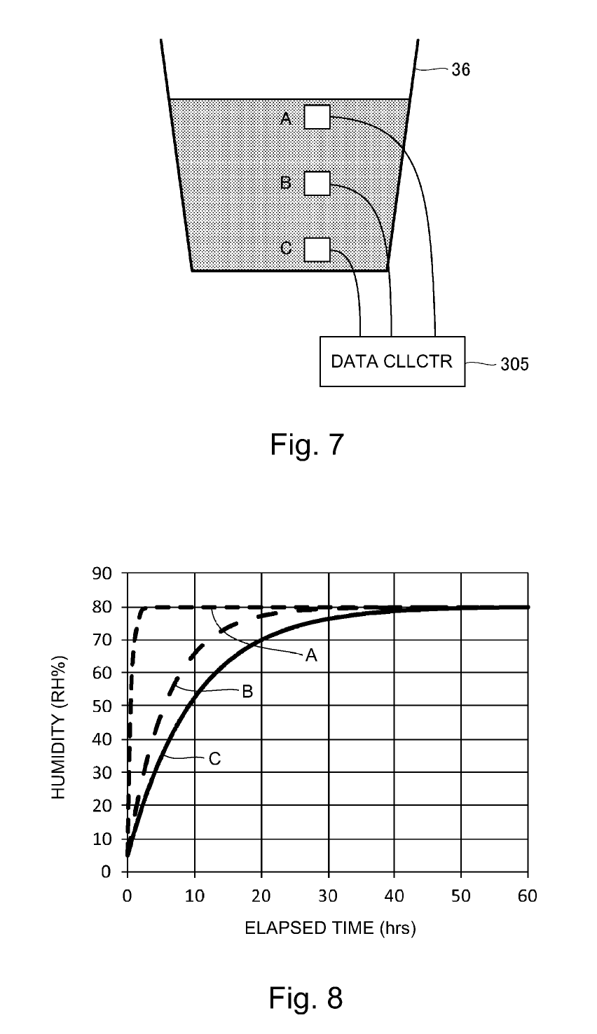

FIG. 7 is an illustration of a simulation of a humidity adjustment phenomenon of the developer with a change in ambient humidity. FIG. 8 is a graph showing a relationship between a depth of the developer and a humidity adjustment time in the simulation. The humidity adjustment of the developer with the humidity change of the ambient air of the developing device requires a time to some extent and therefore a simulation in which the humidity adjustment time of the developer with the humidity change of the ambient air is estimated was conducted.

As shown in FIG. 7, a 200 ml-plastic cup 36 was prepared and in order to check a humidity adjustment state of the developer, holes were bored in the cup 36 at 3 measurement points A, B and C with respect to a height direction. A temperature/humidity sensor was attached to each of portions of the holes. Then, 250 g of the developer which was sufficiently humidity-adjusted in a constant temperature oven in an environment of the temperature of 23° C. and the humidity of 5% RH was placed in the plastic cup 36. The whole plastic cup 36 was placed in a plastic bag for preventing condensation. The plastic bag in which the plastic cup 36 was sealed was moved into a constant temperature oven in an environment of the temperature of 30° C. and the humidity of 80% RH and then the plastic bag was opened. Temperature/humidity data outputted from the temperature/humidity sensors provided at the measurement points A, B and C were collected by a dedicated data collector 305, so that progression of the humidity change in a process in which the humidity of the developer was adjusted to 80% RH was measured.

As shown in FIG. 8, a necessary time to adjust the humidity of the developer to 80% RH is about 15 minutes at an upper portion (A) of the developer but on the other hand, the necessary time is 33 hours at an intermediate portion (B) of the developer and is 50 hours at a bottom (C) of the developer. In FIG. 8, the abscissa represents progression of time, and the ordinate represents the developer humidity at the measurement points A, B and C. The origin of each of the curves represents the time at which the plastic bag is opened.

Accordingly, in the case where ambient temperature and humidity of the image forming apparatus is largely changed during stop of the developing device, similarly as in the plastic cup 36, also in the developing device, it would be considered that a large difference in humidity adjustment speed, i.e., humidity adjustment non-uniformity is generated every depth of the developer (layer).

As shown in FIG. 2, a similar experiment (simulation) was conducted with respect to the developing device 1, it was confirmed that the humidity adjustment speed was changed depending on a depth position of the developer temperature/humidity sensor 51 from the developer surface. As a result, in a left state in which the developing device 1 was stopped, it was turned out that there was a large time difference with respect to the humidity adjustment time between the position close to the developer surface contacting the ambient air and the bottom of the developer. As a result of disposing the developer temperature/humidity sensor 51 at each of portions of the developing device 1 and then checking behavior of the humidity change at each of the portions, it was turned out that the humidity adjustment speed of the developer was largely changed depending on the depth position of the developer.

The developer coated in a thin layer on the developing sleeve 3 is humidity-adjusted to the ambient humidity in the order of several minutes, and also the surface of the developer in the developing device 1 is humidity-adjusted to the ambient humidity in the order of several minutes. On the other hand, in a region inside the developer in the developing device 1, the humidity adjustment speed of the developer to the ambient humidity is slow and therefore it takes several tens of minutes to several tens of hours until the developer is humidity-adjusted to the ambient humidity. For this reason, during a stop period of the developing device, the developer on the developing sleeve 3 and the surface layer of the developer in the developing device 1 are humidity-adjusted but the inside of the developer in the developing device 1 is not readily humidity-adjusted. However, when an operation of the developing device 1 is started, the developer repeatedly passes through the surface of the developer on the developing sleeve 3 and in the developing device 1, and therefore the whole developer is humidity-adjusted quickly.

Accordingly, when the ambient humidity is changed during the stop period of the developing device 1, “humidity adjustment non-uniformity” of the developer in the developing device 1 is generated. In a period immediately after the developing device 1 is stopped, the humidity adjustment of the developer in the developing device 1 to the ambient humidity is not advanced and therefore a degree of the humidity adjustment non-uniformity is small. Further, in the case where the developing device 1 is stopped for 20 hours or more, even at the bottom of the developing device 1 where the developer less contacts the air, the humidity adjustment is completed and therefore the degree of the humidity adjustment non-uniformity is small.

However, in an intermediate stop time of about 6 to 12 hours, a difference in developer humidity becomes large between the portion where the developer in the developing device 1 contacts the air and the portion where the developer in the developing device 1 less contacts the air. Further, in the case where the developer temperature/humidity sensor 51 is buried and disposed in the developer, a detected humidity varies depending on the depth position of the developer temperature/humidity sensor 51.

For that reason, when the developing device 1 is actuated in a state in which there is the humidity difference among the respective portions of the developer in the developing device 1, during a period of several tens of seconds to several minutes from the actuation, a detected value of the humidity by the developer temperature/humidity sensor 51 is largely changed in a process in which the developer is stirred to eliminate the humidity difference among the respective portions. For this reason, it is difficult that the developer temperature/humidity sensor 51 accurately detects an average developer humidity of the developer in the developing device 1 during the period of several tens of seconds to several minutes from the actuation, so that erroneous detection of the humidity of the developer is liable to occur. When the erroneous detection of the developer humidity is generated, an error in control for estimating the toner charge amount Q/M to keep the image density at a certain level is increased, so that a density fluctuation of an output image is liable to occur.

In the following embodiments, temperature progression when the position of the developer temperature/humidity sensor 51 is determined and the developing device 1 is placed in a stop (rest) state is measured to obtain a correction amount of the developer humidity depending on an elapsed time after the developing device 1 is stopped. Then, a toner image forming condition is determined by using developer humidity obtained by subjecting output information of the developer temperature/humidity sensor 51 to correction depending on an elapsed time after the developing device 1 is stopped.

### Embodiment 1

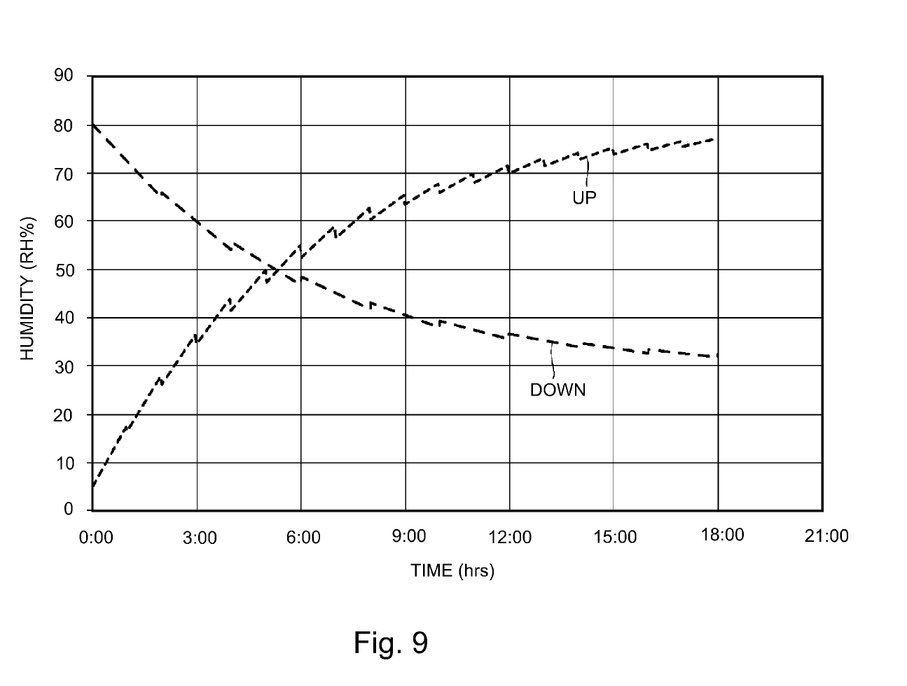

FIG. 9 is an illustration of a measurement result of a correction value of detected humidity.

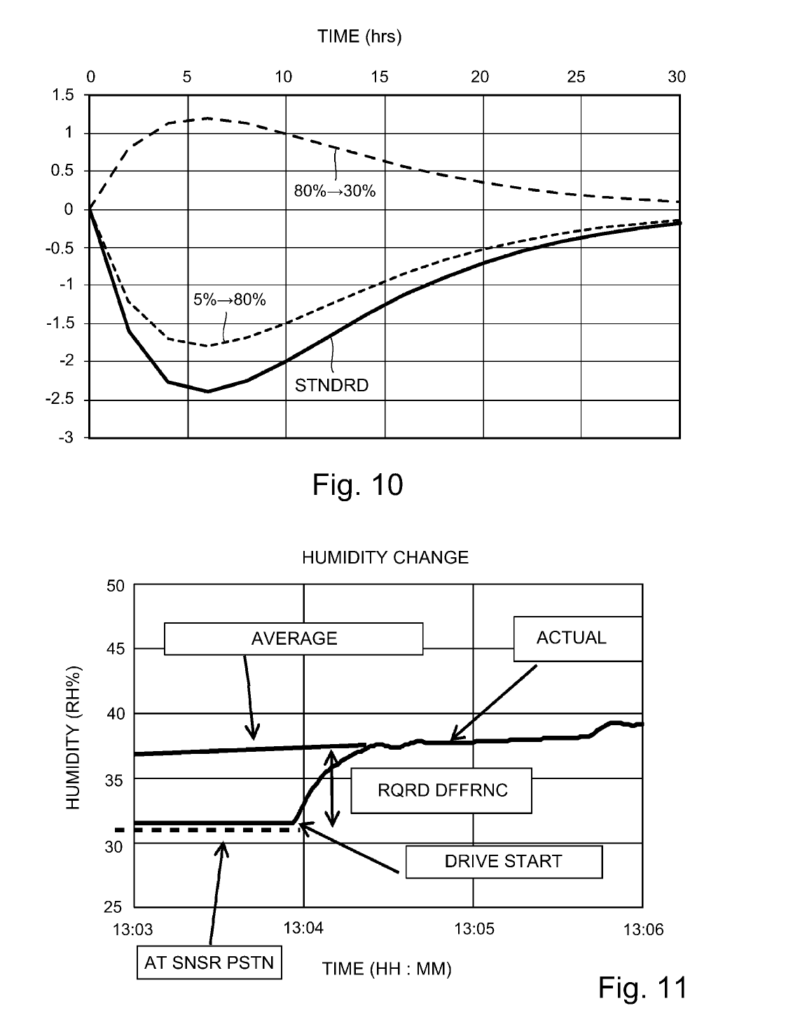

FIG. 10 is an illustration of a table of the correction value of the detected humidity.

FIG. 11 is an illustration of a change in detected humidity of the developer temperature/humidity sensor during actuation of the developing device.

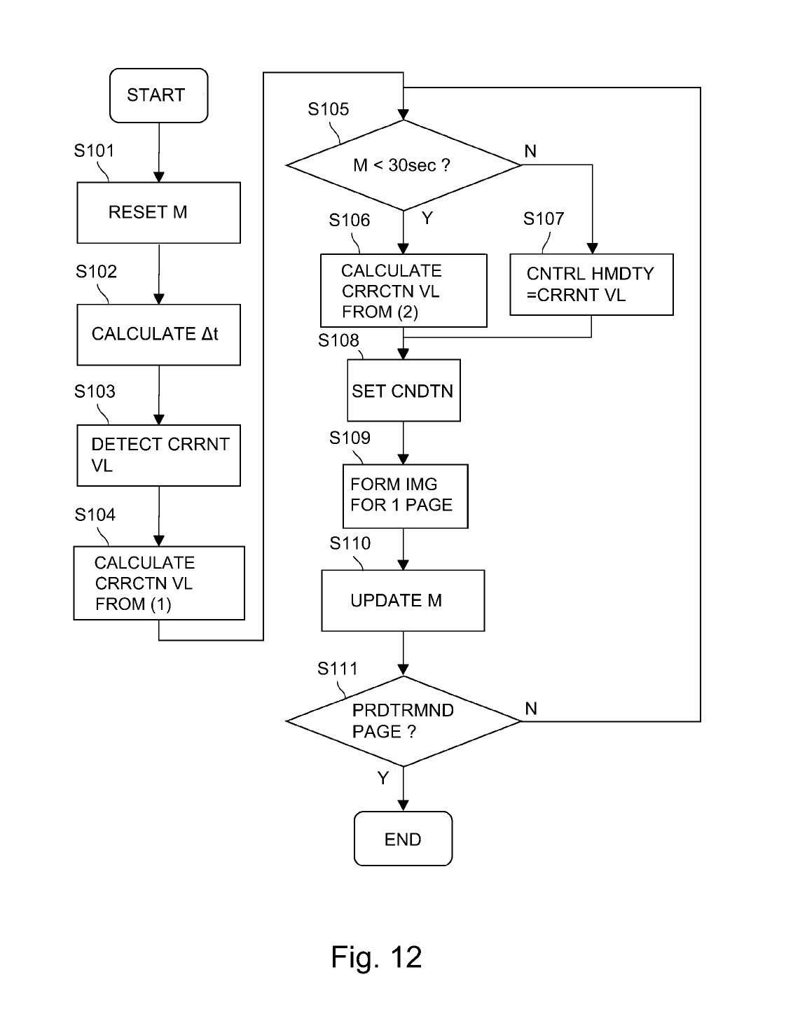

FIG. 12 is a flow chart of control in Embodiment 1.

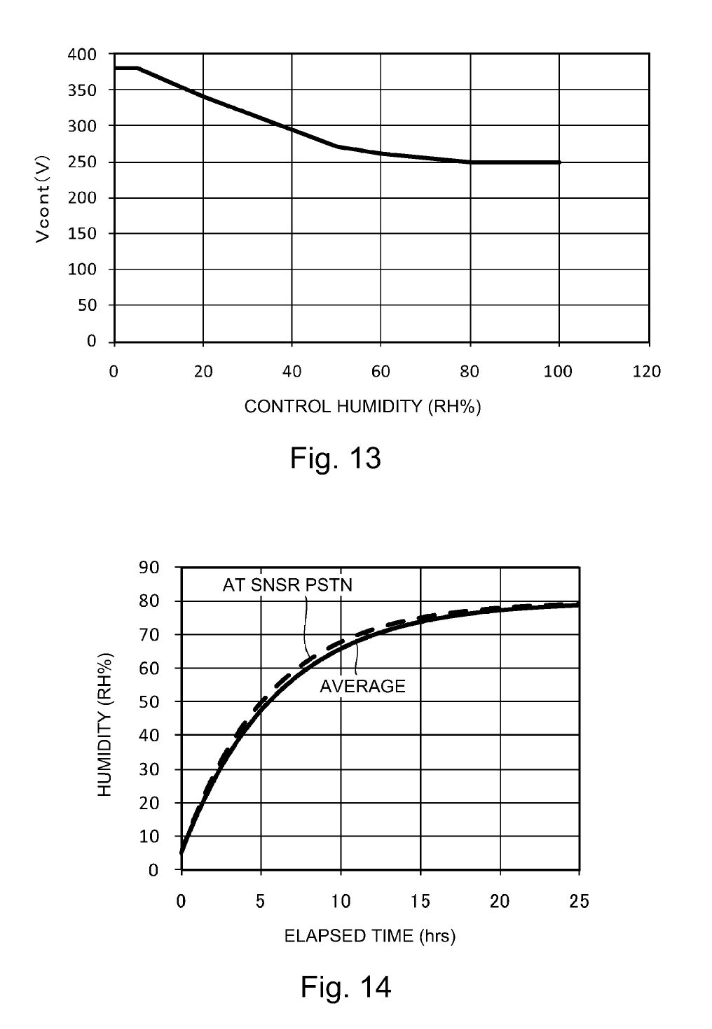

FIG. 13 is an illustration of setting of a developing contrast in Embodiment 1.

As shown in FIG. 2, the developing device 1 carries the developer on the developing sleeve 3 as an example of a developer carrying member and develops the electrostatic image into the toner image on the photosensitive drum as the image bearing member with the stirring of the developer. The developer temperature/humidity sensor 51 as an example of a humidity sensor develops the humidity of the developer in contact with the developer in the developing device 1. The printer controller 301 as an example of the controller selects and executes, in the case where the developing device 1 starts image formation from its portion state, an operation in a first mode or a second mode on the basis of an elapsed time from the start of the image formation.

The developer temperature/humidity sensor 51 is buried and disposed in the developer at an intermediate height of the partition wall 15 at the communicating wall 15 where the developer is delivered from the stirring chamber 12 to the developing chamber 11, and directly measures the developer humidity. The printer controller 301 estimates the toner charge amount Q/M on the basis of the output information of the developer temperature/humidity sensor 51 and then sets the developing contrast during the toner image formation on the basis of the estimated value, so that the image density and the color are stabilized.

Humidity progression “under a condition in which the humidity adjustment non-uniformity is generated” while stopping the developing device 1 as it is and humidity progression “in the case where the humidity adjustment non-uniformity is temporarily eliminated at a certain time” by driving the developing device 1 for a while were measured.

First, an experiment on the assumption that the humidity is abruptly increased immediately after the image forming apparatus 100 is stopped was conducted.

The developer sufficiently humidity-adjusted in a low humidity environment of 23° C. and 5% RH was filled in the developing device 1, and then the developing device 1 is placed in a high humidity environment of 23° C. and 80% RH. Then, an operation in which the developing device 1 was stopped for 59 minutes and 30 seconds and then was driven for 30 minutes was repeated.

As shown in FIG. 9, the humidity progression of the developer humidity detected by the developer temperature/humidity sensor 51 was a curve during humidity rise (“UP”) indicated by a fine broken line. The curve during humidity rise is a saw-tooth shape, in which a linear portion represents the humidity progression “under the humidity adjustment non-uniformity condition” and a V-shaped portion adjacent to the linear portion represents the humidity progression “under no humidity adjustment non-uniformity condition” in which the developer is stirred to be humidity-adjusted as a whole. A curve obtained by smoothing the V-shaped portions and then by connecting the linear portions provides progression of “developer humidity averaged as a whole” in the state in which the developing device 1 is stopped.

Next, an experiment on the assumption that the humidity is abruptly lowered immediately after the image forming apparatus 100 is stopped was conducted.

The developer sufficiently humidity-adjusted in a high humidity environment of 23° C. and 80% RH was filled in the developing device 1, and then the developing device 1 is placed in a low humidity environment of 23° C. and 30% RH. Then, an operation in which the developing device 1 was stopped for 119 minutes and 30 seconds and then was driven for 30 minutes was repeated.

As shown in FIG. 9, the humidity progression of the developer humidity detected by the developer temperature/humidity sensor 51 was a curve during humidity fall (“DOWN”) indicated by a fine broken line. The curve during humidity fall is a saw-tooth shape, in which a linear portion represents the humidity progression at a position of the developer temperature/humidity sensor 51 before the stirring and a V-shaped portion adjacent to the linear portion represents the humidity progression at the position of the developer temperature/humidity sensor 51 during the stirring. A curve obtained by smoothing the V-shaped portions and then by connecting the linear portions provides progression of average heat of the developer as a whole in the case where the developing device 1 is continuously stopped.

As shown in FIG. 10, a curve from 5% to 80% was obtained by calculating a difference between the linear portion and V-shaped portion at each time of the curve during the humidity rise in FIG. 9. Further, a curve from 80% to 30% was obtained by calculating a difference between the linear portion and V-shaped portion at each time of the curve during the humidity fall in FIG. 9. Further, based on the curve from 5% to 80%, a curve indicated by a thick solid line corresponding to a humidity change from 0% to 100% was obtained. The curve indicated by the thick solid line shows a normalized value (standard humidity difference) in the case where the humidity is changed from 0% to 100% and is common, inclusive of the sign, to the case where the curve is normalized form the curve of 5% to 80% and the case where the curve is normalized from the curve of 80% to 30%.

As shown in FIG. 10, each of the curves has a peak in the neighborhood of an elapsed time of 6 hours after the humidity change. A difference between the humidity at the position of the developer temperature/humidity sensor 51 and the average humidity of the developer as a whole is small immediately after the humidity change and after a lapse of 20 hours, and is gradually increased until the elapsed time reaches 6 hours and then is gradually decreased after the lapse of 6 hours.

For this reason, in the case where the average humidity of the developer as a whole is estimated by using the output information of the developer temperature/humidity sensor 51, immediately after the humidity change and after the lapse of 20 hours from the humidity change, the output information can be used as the whole developer average humidity as it is without being corrected. Further, there is a need to change a correction amount so that the correction amount is gradually increased from after the humidity change until the elapsed time reaches 6 hours and so that the correction amount is gradually decreased after the lapse of 6 hours from the humidity change.

A humidity correction value (% RH) with respect to the humidity detected by the developer temperature/humidity sensor 51 is obtained from the standard humidity difference indicated by the thick solid line in FIG. 10 in accordance with the following equation (1).

Humidity correction value(% RH)=(standard humidity difference)×{(current humidity)−(humidity during preceding stop)} (1)

As shown in FIG. 10, a negative value of the standard humidity difference means that negative value correction is made with respect to humidity increase or that positive value correction is made with respect to humidity decrease. This means that the developer temperature/humidity sensor 51 grasps the humidity change faster than that at the average humidity adjustment speed, i.e., that the developer temperature/humidity sensor 51 is disposed at a position closer to the developer surface than an ideal toner/humidity detecting position in the developing device 1 and the correction value functions in a direction in which the humidity change is eliminated. For that reason, when the position of the developer temperature/humidity sensor 51 is close to the bottom of the developing device 1, the value of the standard humidity difference is positive.

For example, in the case where the humidity is increased from 5% to 80% immediately after the image forming apparatus 100 is stopped, when the image forming apparatus 100 is actuated after a lapse of 5 hours from the stop thereof, the developing contrast is set on the basis of humidity lower than the humidity detected by the developer temperature/humidity sensor 51 by 1.75%. As a result, even when the image formation is immediately started without idling the developing device 1 for 30 seconds or more, a proper developing contrast depending on the average humidity of the developer as a whole can be set. The humidity value is improved by less than about 2% RH but in view of demands for color stability in the market in recent years, an effect of correcting an erroneously detected humidity value in the present invention is important.

As shown in FIG. 11 with reference to FIG. 2, assuming that the humidity is lowered immediately after the stop of the developing device 1 and then the drive of the developing device 1 is started after a lapse of 6 hours in the stop state, the developer temperature/humidity sensor 51 detects the developer humidity lower than the average humidity of the developer as a whole at that time, and therefore the detected humidity is increased with stirring. Then, when the drive of the developing device 1 is effected for about 30 seconds, the average humidity in the developing device 1 is detected. The humidity correction value obtained by using the graph of FIG. 10 corresponds to a required correction humidity difference (“RQRD DFFRNC”) in FIG. 11.

As shown in FIG. 12 with reference to FIG. 6, the printer controller 301 selects the operation in the second mode when the elapsed time from the start of the image formation is 30 seconds or more as an example of a first predetermined time or more. However, the printer controller 301 selects the operation in the first mode when the elapsed time from the start of the image formation is less than 30 seconds as an example of less than first predetermined time. In the operation in the first mode, the developing contrast depending on ambient humidity history of the developing device 1, during the stop period of the developing device 1 and a detection result of the developer temperature/humidity sensor 51 is set. In the operation in the second mode, irrespective of a humidity history of the developing device 1 during the stop period of the developing device 1, the developing contrast depending on the detection result of the developer temperature/humidity sensor 51 is set.

In the operation in the first mode, the developing contrast depending on the detection result of the developer temperature/humidity sensor 51 is corrected depending on ambient humidity history in the stop period of the developing device 1, so that a developing contrast correction amount on the basis of the humidity history is decreased with a lapse of time from the start of the image formation. In the operation in the first mode, the developing contrast correction amount on the basis of the humidity history is increased with a longer elapsed time when the elapsed time from the ambient humidity change of the developing device 1 in the stop period is less than 6 hours as an example of less than a second predetermined time. In the operation in the first mode, the developing contrast correction amount on the basis of the humidity history is decreased with a longer elapsed time when the elapsed time from the ambient humidity change of the developing device 1 is not less than 6 hours as an example of not less than a second predetermined time. In the operation in the first mode, the developing contrast correction amount is increased with a larger change amount of the humidity in the ambient humidity change of the developing device 1 in the stop period.

The printer controller 301 corrects an erroneously detected humidity value of the developer temperature/humidity sensor 51 by using the standard humidity difference in FIG. 10 obtained in advance. The printer controller 301 sets, when it receives an instruction to start a “series of image forming operations (job)”, a timer value M for counting an elapsed time (sec) from the actuation at 0 (sec) with start of the job (S101).

The printer controller 301 calculates a left time Δt (hours) from preceding image formation by a time-measuring means in the CPU 302 (S102). The printer controller 301 detects a current humidity value of the developer temperature/humidity sensor 51 (S103). The printer controller 301 starts the table (graph) of the standard humidity difference with the left time Δt shown in FIG. 10. The printer controller 301 calculates the humidity correction value, by using the above-described equation (1), from the standard humidity difference at the left time 1t and the current developer humidity value (S104).

As shown in FIG. 12, immediately after actuation of the developing device 1, there is a need to always modify the humidity correction value (required humidity correction difference) but there is a need to decrease the humidity correction value with a lapse of the time from the actuation, i.e., with an increasing degree of elimination of the humidity adjustment non-uniformity of the developer. When the drive of the developing device 1 is effected for about 30 seconds, the developer temperature/humidity sensor 51 detects the average humidity of the developer and therefore there is a need to converge the humidity correction amount to zero. For this reason, the printer controller 301 discriminates whether or not the timer value M is less than 30 (sec) (S105). In the case of the timer value M<30 (sec) (Y of S105), the humidity for control is calculated on the basis of the following equation (2) (S106).

$$Humidity for control ( \% RH ) = ( current developer humidity value ) + ( humidity correction value ) \times ( 30 - M ) / 30 \qquad ( 2 )$$

As shown in the equation (2), the printer controller 301 changes the humidity correction value depending on the elapsed time Δt after the stop of the developing device 1 to gradually decrease a degree of the effect of the humidity correction value, thus correcting a measurement error of the developer temperature/humidity sensor 51.

The printer controller 301 sets the humidity for control (% RH) at a current developer temperature/humidity value in the case where the timer value M is not less than 30 (sec) (N of S105) (S107). This is because when the drive of the developing device 1 is effected for 30 (sec), the developer temperature/humidity sensor 51 detects the average humidity of the developer in the developing device 1 and thus the measurement error is eliminated. The printer controller 301 makes setting of the image forming condition when the humidity for control is calculated (S108). As shown in FIG. 13, the printer controller 301 stores a value of a developing contrast Vcont with respect to the humidity for control, and depending on the value, sets the dark portion potential VD, the DC voltage Vdc of the developing voltage and laser output of the exposure device 22.

Thereafter, every image formation of one page (S109), the timer value M is updated by adding a value (1 sec in this embodiment) corresponding to image formation of one sheet (S110). Thereafter, when the image is formed on a predetermined number of sheets (pages) in the current job (Y of S111), the image formation is ended at that time. When the number of sheets does not reach the predetermined number of sheets (pages) (N of S111), the image formation of subsequent sheet (page) and later is continued (S105).

According to the control in Embodiment 1, correspondingly to the time Δt in which the developing device 1 is stopped, the correction amount is controlled so that the correction amount is small when the stop time is close to zero and is then increased until the stop time reaches a predetermined time and then is decreased after a lapse of the predetermined time. Thus, by correcting the detected value of the developer temperature/humidity sensor 51 depending on “behavior of humidity adjustment non-uniformity”, setting accuracy of the developing contrast Vcont is enhanced, so that image density non-uniformity can be suppressed.

According to the control in Embodiment 1, a problem of “erroneous detection of the developer temperature/humidity due to the humidity adjustment non-uniformity” as in the conventional control is reduced, so that an object of the present invention, i.e., “suppression of image density fluctuation due to the erroneous detection” is achieved.

In Embodiment 1, correspondingly to the stop time of the developing device 1, the correction amount is controlled so that the correction amount is small when the stop time is close to zero and is then increased until the stop time reaches a predetermined time and then is decreased after a lapse of the predetermined time. By correcting the detected value of the developer temperature/humidity sensor 51 depending on the behavior of humidity adjustment non-uniformity, it is possible to achieve the object of the present invention.

In Embodiment 1, an absolute value of the difference between the detected humidity and the correction humidity is gradually increased with an increasing stop time (period) and therefore it is possible to avoid excessive correction of the detected humidity in the case where the stop time is short, and it is possible to avoid in sufficient correction of the detected humidity in the case where the stop time approaches a predetermined time. Further, after the stop time reaches the predetermined time, the absolute value of the difference between the detected humidity and the correction humidity is gradually decreased with an increasing stop time and therefore it is possible to avoid excessive correction of the detected humidity after the stop time reaches the predetermined time.

In Embodiment 1, even when a large humidity slope of the developer is generated by ambient humidity change during the stop period of the developing device, without idling the developing device for an unnecessary time, it is possible to set a toner image forming condition in which reproducibility of image density is high.

### <Drive of Developing Device for 30 Seconds>

In the experiment in FIG. 9, the influence of the drive of the developing device 1 for 30 seconds on the humidity measurement of the developer as a whole will be described. The humidity adjusting speed of the developing device 1 is represented by a time constant when a change thereof is approximated by an exponential function, and is 30 minutes during the drive and is 360 minutes during the stop of the drive.

On the other hand, 30 seconds of the drive of the developing device 1 is shorter than the time constant of 30 minutes and is a sufficient time required for a eliminating the humidity adjustment non-uniformity of the developer in the developing device 1. The experiment in which the developing device is left standing without being driven cannot avoid the influence of the humidity adjustment non-uniformity and therefore the experiment was conducted in the above-described manner.

In this embodiment, in the case where the image formation is started from the state in which the developing device is stopped, when the drive time of the developing device from the start of the image formation is less than a predetermined time, on the basis of the detection result of the above-described humidity sensor obtained before and after the start of the drive of the developing device, the operation in the mode in which the image forming condition is corrected is executed but the present invention is not limited thereto. For example, in the case where the stop period of the developing device is short or in the case where it would be considered that the humidity adjustment non-uniformity is not generated, the operation in the above-described correction mode may also be not required to be executed. In this case, the humidity correction can be performed by appropriately adjusting the standard humidity difference in the equation (1) described above.

### Embodiment 2

In Embodiment 1, as the adjusting means for adjusting the toner image forming condition depending on the humidity, the developing contrast Vcont was used as an example. However, in the setting of the image forming condition in FIG. 12 (S108), the value for the setting is not limited to the developing contrast Vcont. It is possible to use various values such as an output value of the transfer power source 43 and the value of LUT read by the LUT portion 206.

In Embodiment 2, selection of the LUT (look-up table) is made in the following manner. The printer controller 301 defines 32 environmental classifications different in combination of temperature and humidity by classifying ambient environment into 4 levels for temperature and 8 levels for humidity. The printer controller 301 stores 32 γLUTs in the ROM 210 with respect to the 32 environmental classification from a first environmental section to a 32th environmental section, and develops a proper single (one) γLuT on the RAM 211 in accordance with an instruction (command) from the exposure controller 209 and then uses the γLuT.

The γLuT is a table, for determining 256 output levels with respect to 256 input levels, in which whether or not an output product can obtain a desired density gradation level when an input image signal is subjected to laser exposure with a pulse width at what level is described. The printer controller 301 determines, when a value of the humidity for control (% RH) is obtained, the environmental section in accordance with the obtained value and selects a corresponding γLUT, thus adjusting a pulse signal used for driving the exposure device 22. As a result, a surface exposure time of the photosensitive drum 28 is changed, so that the developing contrast Vcont is changed and thus a density change is properly corrected.

In Embodiment 1, the developer temperature/humidity sensor 51 develops the developer humidity at a position shallower than a depth position of the developer where the humidity values detected before and after the developing device 1 is operated for a first predetermined time are equal to each other in a second predetermined time. For this reason, when the ambient humidity change of the developer in the developing device 1 in the stop period is the humidity rise, the developing contrast in the operation in the first mode is higher than the developing contrast in the operation in the second mode.

However, the case where the developer temperature/humidity sensor 51 develops the developer humidity at a position deeper than a depth position of the developer where the humidity values detected before and after the developing device 1 is operated for the first predetermined time are equal to each other in the second predetermined time is contrary to the above case. When the ambient humidity change of the developer in the developing device 1 in the stop period is the humidity rise, the developing contrast in the operation in the first mode is lower than the developing contrast in the operation in the second mode.

### Embodiment 3

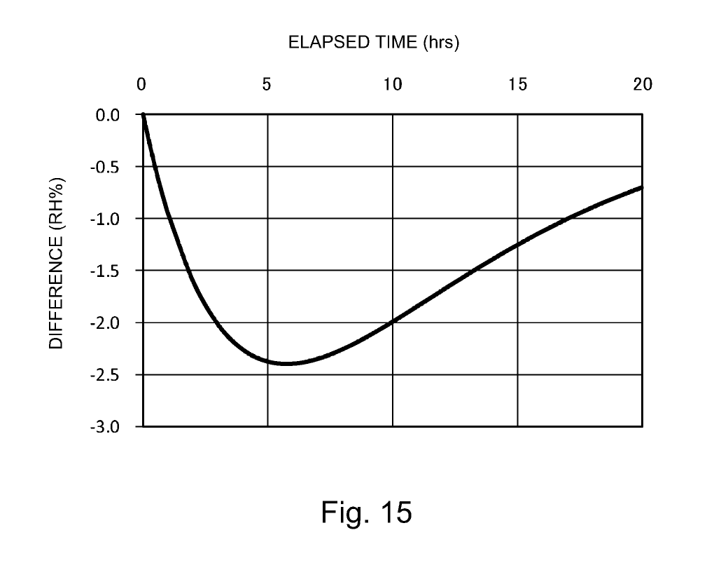

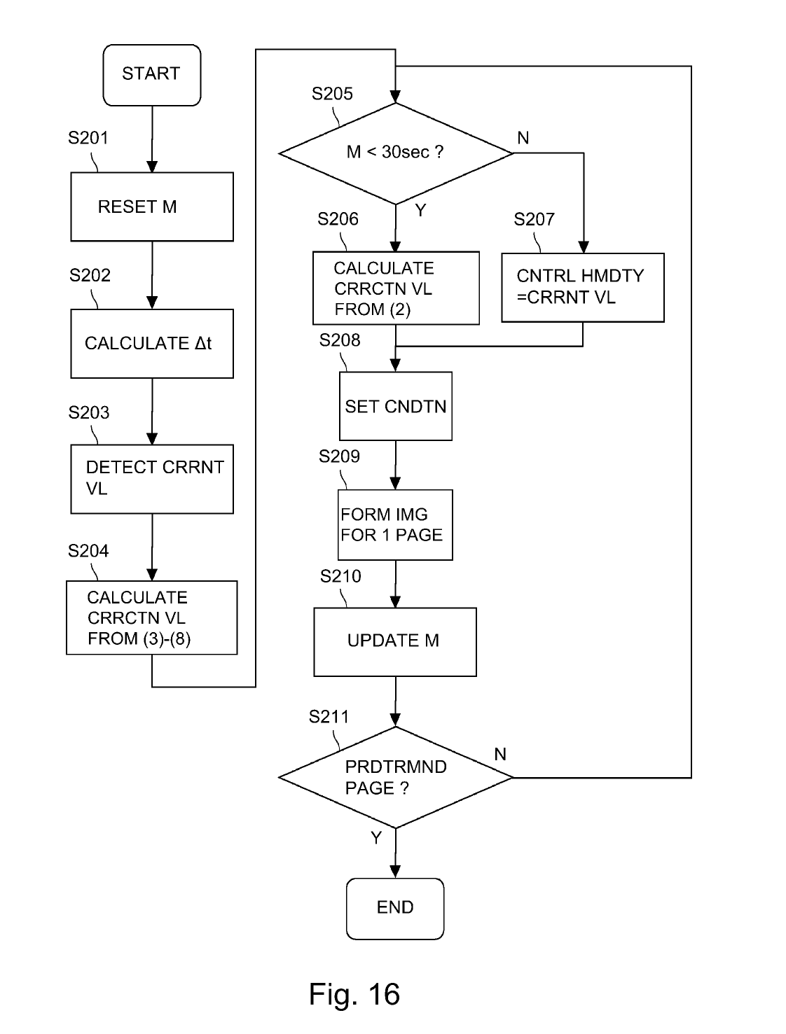

FIG. 14 is an illustration of a humidity adjustment curve of the developer after stop of the developing device. FIG. 15 is an illustration of a humidity correction value at each time after the stop of the developing device. FIG. 16 is a flow chart of control in Embodiment 3.

As shown in FIG. 2, in Embodiment 1, the standard humidity difference table shown in FIG. 10 was prepared by conducting the experiment in advance, and then the humidity correction value (% RH) was obtained from the standard humidity difference. On the other hand, in Embodiment 3, on the basis of output information of the environment sensor 52 and temperature information of the developer temperature/humidity sensor 51, an individual humidity correction value (% RH) at each time after the stop of the developing device 1 is directly computed.

With respect to the curve of 5% to 80% shown in FIG. 9, when only the V-shaped portions of the sawtooth curve are extracted and plotted, an exponential function as indicated by a solid line in FIG. 14 is drawn. The solid line in FIG. 14 shows a change in average developer humidity obtained by eliminating the humidity adjustment non-uniformity of the developer in the developing device 1 at each time after the stop of the developing device 1.

Similarly, with respect to the curve of 5% to 80% shown in FIG. 9, when only the linear portions of the sawtooth curve are extracted and plotted, an exponential function as indicated by a broken line in FIG. 14 is drawn. The broken line in FIG. 14 shows a change in developer humidity at the position of the developer temperature/humidity sensor 51 in the state in which the humidity adjustment non-uniformity of the developer in the developing device 1 is left.

In this embodiment, assuming that the humidity change is generated immediately after the stop of the developing device, the developing contrast correction value during actuation is obtained by making approximation of the humidity change of the developer in the stop period by using the two exponential functions indicated by the solid line and the broken line in FIG. 14. The correction value is obtained as a difference amount between the solid line curve and the broken line curve shown in FIG. 4 at the time of end of the stop period. The two exponential functions indicated by the solid line and the broken line are estimated on the basis of the output information of the environment sensor 52 and the temperature information of the developer temperature/humidity sensor 51.

The environment sensor 52 measures ambient temperature and humidity of the developing device 1. The printer controller 301 estimates average developer humidity in the developing device 1 to obtain a current developer average humidity estimation value RHa. The printer controller 301 estimates the temperature and humidity measured by the developer temperature/humidity sensor 51 to obtain a developer humidity estimation value RHs at the position of the developer temperature/humidity sensor 51. The printer controller 301 obtains a humidity correction value (% RH) as a difference between the developer average humidity estimation value RHa and the developer humidity estimation value RHs.

The printer controller 301 computes a weight-basis absolute humidity W (g/kg D.A.: weight of water contained in 1 kg of dry air) in the environment of the developing device 1 from the output information of the environment sensor 52 in the image forming apparatus 100. The printer controller 301 then obtains an inside temperature Tc (° C.) of the developing device 1 from the output information of the developer temperature/humidity sensor 51. This is because the inside temperature Tc may preferably be detected at a point close to the developer itself. However, the inside temperature Tc may also be a measured temperature value or an estimated value in the neighborhood of the developing device 1. The printer controller 301 obtains a saturated aqueous (water) vapor pressure P (Tc) at Tc (° C.) from an experimental equation of Tetens.

P(Tc)=511×10(7.5×Tc/(Tc+237.3)) (3)

At the inside temperature Tc (° C.), a saturated weight(-basis) absolute humidity Ws and a relative humidity rh are represented as follows.

Ws=622×P(Tc)/(101300−P(Tc)) (4)

rh=W/Ws (5)

Here, an elapsed time from preceding (previous) stop of the developing device 1 is Δt, a value of the developer temperature/humidity sensor 51 at the time of preceding stop of the developing device 1 is RHm, and a current ambient relative humidity of the developing device 1 obtained at a current temperature Tc is rh. In this case, the current developer average humidity estimation value RHa is represented as follows.

RHa(% RH)=(RHm−rh)×exp(−Δt/(βa)+rh (6)

In the equation (6), βa is a time constant (unit: hours) which represents the humidity adjusting speed at the average humidity of the developer in the developing device 1, and as shown in FIG. 14 by the solid line, βa is 6 hours in this embodiment. Further, the developer humidity estimation value RHs at the position of the developer temperature/humidity sensor 51 is represented as follows.

RHs(% RH)=(RHm−rh)×exp(−Δt/(βs)+rh (7)

In the equation (7), βs is a time constant (unit: hours) which represents the humidity adjusting speed at the position of the developer temperature/humidity sensor 51, and as shown in FIG. 14 by the broken line, βs is 5.5 hours in this embodiment.

As shown in FIG. 14, the humidity correction value (% RH) at the elapsed time Δt is a value of the difference between the current developer average humidity estimation value RHa and the developer humidity estimation value RHs at the position of the developer temperature/humidity sensor 51.

Humidity correction value(% RH)=RHa−RHs (8)

The printer controller 301 executes calculation of the equations (3) to (8) to obtain the humidity correction value (% RH) at each time after the stop of the developing device 1. Even when the table is not prepared as shown in FIG. 10 by conducting the experiment in advance, on the basis of the output information of the environment sensor 52 and the temperature information of the developer temperature/humidity sensor 51, it is possible to calculate the humidity correction value (% RH) in real time as shown in FIG. 15.

The printer controller 301 obtains, similarly as in Embodiment 1, the developer average humidity by adding the humidity correction value (% RH) to the humidity value detected by the developer temperature/humidity sensor 51, thus correcting the erroneous detection of the humidity due to the humidity adjustment non-uniformity. The printer controller 301 sets the developing contrast Vcont during the image formation by using the corrected developer average humidity. As shown in FIG. 13, the printer controller 301 stores a value of a developing contrast Vcont with respect to the humidity for control, and depending on the value, sets the dark portion potential VD, the DC voltage Vdc of the developing voltage and laser output of the exposure device 22.

As shown in FIG. 16 with reference to FIG. 6, the printer controller 301 sets, when it receives an instruction of an image forming job, a timer value M for counting an elapsed time (sec) from the actuation at 0 (sec) with start of the job (S201).

The printer controller 301 calculates a left time Δt (hours) from preceding image formation by a time-measuring means in the CPU 302 (S202). The printer controller 301 detects current pieces of the output information of the environment sensor 52 and the developer temperature/humidity sensor 51 (S203). The printer controller 301 calculates the humidity correction value by performing computations of the equations (3) to (8) (S204). The contents of the steps S203 and S204 are as described above. Subsequent control steps are similar to those in Embodiment 1.

According to the control in Embodiment 3, it is possible to make the correction which cannot be made by the table reading method as described above with reference to FIG. 10. In the case where the whole amount of the developer in the developing device 1 is changed, in Embodiment 1, it is possible to calculate the humidity by scaling of the abscissa of the graph in FIG. 11. Also in Embodiment 3, until the equation (6), the average developer humidity is used and therefore it is possible to meet the humidity change by changing the time constant βa.

However, in the equation (7) in Embodiment 3, by using the time constant βs, it is possible to reflect a parameter at the depth position of the developer temperature/humidity sensor 51 with respect to the developer surface, so that an effect which cannot be obtained in Embodiment 1 can be achieved.

According to the control in Embodiment 3, the detected humidity of the developer temperature/humidity sensor 51 in the state in which the humidity adjustment non-uniformity is generated is estimated from the water content of the image forming apparatus and the temperature of the developing device. Further, the detected humidity of the developer temperature/humidity sensor 51 in the state in which the humidity adjustment non-uniformity is eliminated by the stirring and thus the developer humidity is substantially uniformized is also estimated. Then, the two estimation values are compared, so that the developing contrast can be precisely corrected correspondingly to the behavior of the humidity adjustment non-uniformity. Further, it is possible to make the correction with respect to the developer surface.

### Embodiment 4

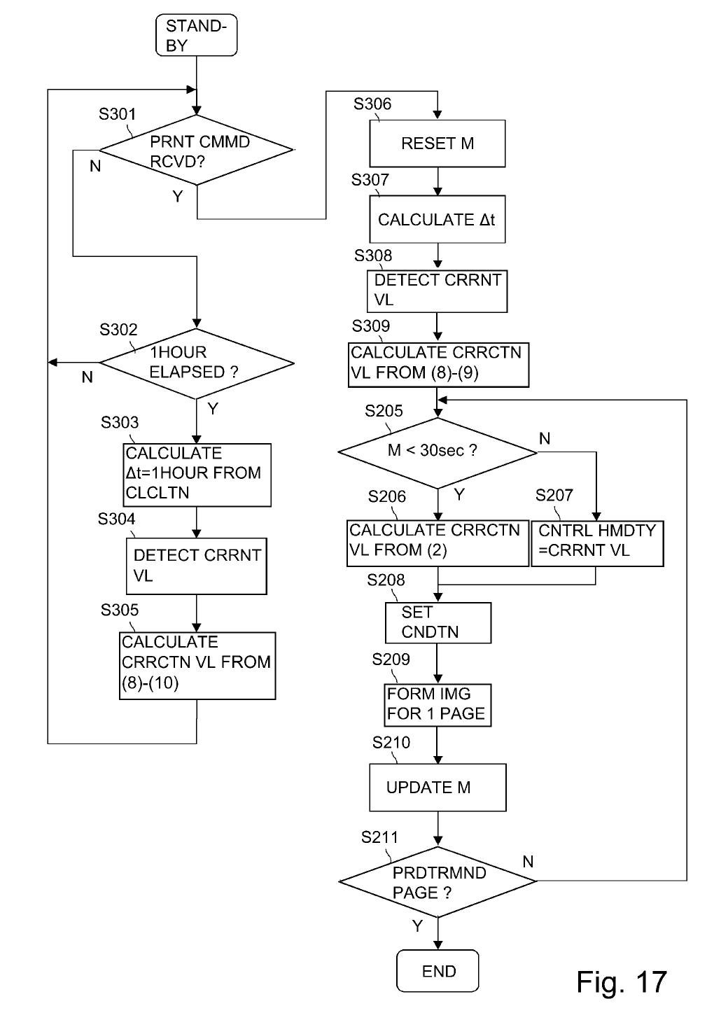

FIG. 17 is a flow chart of the control in Embodiment 4. In Embodiments 1 and 3, the case where the environment is changed from the first environment to the second environment at an initial stage in the stop period, such as the case where an air conditioner is turned off concurrently with the stop of the image forming apparatus is assumed. For this reason, there is a possibility that the correction accuracy is lowered in the case where the environment is changed from the first environment to the third environment via the second environment at the initial stage in the stop period and in the case where the environment is continuously changed. Therefore, in this Embodiment 4, the start time of the stop period is postponed by 1 hour every 1 hour during the stop period of the developing device 1, and then the control in Embodiment 3 is effected. Every 1 hour, the start time of the stop period and an estimation humidity of the developer at that time are updated (renewed), and on the basis of the finally updated estimation humidity of the developer and a current detection humidity (at the time of actuation) of the developer temperature/humidity sensor 51, the humidity of the developer is corrected to obtain a value of the humidity for control until a lapse of 30 seconds from the actuation. Then, as shown in FIG. 13, the developing contrast is set on the basis of the value of the humidity for control.

In this embodiment, in the image forming apparatus 100 shown in FIG. 1, similarly as in Embodiment 3, the developer average humidity estimation value RHa and the developer humidity estimation value RHs are estimated on the basis of the output of the environment sensor 52 and the output of the developer temperature/humidity sensor 51. However, in the control in this embodiment, after the stop of the developing device 1, every 1 hour, the values of the developer average humidity estimation value RHa and the developer humidity estimation value RHs are calculated in real time. In this case, in place of the values of RHm in the equations (6) and (7) in Embodiment 3, values RHsm and RHam which were calculated 1 hour before the current time as RHs and RHa, respectively, are used. This is the feature of this embodiment.

By such control, even in the case where the environment during the stop of the developing device 1 is changed in a complicated manner, a value of (RHs−RHa) as the humidity correction value can be calculated in a historical manner, so that a more accurate correction value can be obtained.

As shown in FIG. 17 with reference to FIG. 6, the environment sensor 52 detects the temperature and humidity of the developing device 1 in a disposition environment. The printer controller 301 as an example of a history recording portion intermittently actuates the environment sensor 52 and the developer temperature/humidity sensor 51 in the stop period of the developing device 1 to record the history of the humidity of the developer. In the operation in the first mode, the developing contrast is corrected on the basis of the finally recorded developer humidity and the developer humidity detected by the developer temperature/humidity sensor 51 at the time of actuating the developing device 1.

The printer controller 301 discriminates, in the case where it does not receive the print command (instruction) (N of S301), whether or not 1 hour is elapsed from start of stand-by of printing or from preceding humidity measurement (S302).

The printer controller 301 continues the stand-by of the printing (S301) in the case where 1 hour or more is not elapsed (N of S302). When 1 hour is elapsed (Y of S302), current values RHa and RHs are obtained from RHam and RHsm where are calculated 1 hour before the current time as the preceding values RHa and RHs (S304, S305).

That is, the elapsed time Δt=1 hour from the time of the preceding calculation of the correction value is calculated (S303). Then, a weight absolute water content W in the ambient environment is detected by the environment sensor 52, and a current temperature value T and a current humidity value RH are detected by the developer temperature/humidity sensor 51 (S304). Then, from equations (9) and (10) below, the values RHa and RHs are obtained, and the humidity correction value (% RH) is obtained from an equation (11) below.

RHa(% RH)=(RHam−rh)×exp(−Δt/βa)+rh (9)

RHs(% RH)=(RHsm−rh)×exp(−Δt/βs)+rh (10)

Humidity correction value(% RH)=RHs−RHa (11)

The printer controller 301 sets, in the case where it receives the print command (Y of S301), the timer value M for counting the elapsed time after the actuation at 0 (sec) (S306). Then, the printer controller 301 calculates a left time Δt (min) from the time of the preceding calculation of the correction value (S307).

The printer controller 301 obtains the weight absolute water content W in the ambient environment from the output of the environment sensor 52, and obtains the current temperature value T and the current humidity value RH from the output of the developer temperature/humidity sensor 51 (S308).

The printer controller 301 calculates the humidity correction value (=RHs−RHa) from the equations (9) and (10) (S309). Subsequent steps are the same as the step S205 and the later steps shown in FIG. 16 in Embodiment 2. Until 30 seconds is elapsed from the actuation of the developing device 1 (Y of S205), the correction amount is gradually decreased, so that the value of the humidity for control is obtained from the equation (2) (S206). As shown in FIG. 13, the developing contrast is set on the basis of the humidity value for control (S208), and then the image formation is executed (S209). When the image formation is ended (Y of S211), the developing device 1 is stopped.

### Other Embodiments

In the present invention, the image forming apparatus is operable in the first mode in which the developing contrast is set on the basis of the ambient humidity history of the developing device in the stop period of the developing device and the detection result of the above-described humidity sensor and in the second mode in which the developing contrast is set on the basis of the detection result of the humidity sensor irrespective of the humidity history in the stop period of the developing device. Further, the description was made by taking, as an example, the operation in the image forming mode in which the operations in the first and second modes were selectively executed on the basis of the elapsed time from the start of the image formation. However, the image forming apparatus is not always required to be configured to perform the operation in the image forming mode. For example, the image forming apparatus may also be configured so that the operation in the image forming mode is selectively executable and thus the operation in the image forming mode is executed only when the image forming mode is selected. For example, an image quality priority mode in which an image quality has priority is provided and then as in the conventional control, the idling for 30 seconds is executed and thereafter the developing contrast is se on the basis of the developer humidity detected by the humidity sensor. On the other hand, in the case where speed has priority, a constitution in which an image forming mode (speed priority mode) according to the above-described embodiments is settable from a setting portion may also be employed.

In the image forming apparatus of the present invention, in the case where the whole developer is not subjected to the humidity adjustment, the developing contrast is corrected depending on the history of the humidity change of the developer in the stop period of the developing device and the detection result of the humidity sensor. For this reason, with respect to the image formation after the actuation of the developing device, even when several tens of seconds is not elapsed from the actuation, the developing contrast after the actuation can be properly set.

Accordingly, in the case where the developer humidity is largely changed during the stop period, without idling the developing device for an unnecessary time, the developing contrast after the actuation can be set properly on the basis of the developer humidity detected by the humidity sensor.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 063880/2012 filed Mar. 21, 2012, which is hereby incorporated by reference.

What is claimed is:

1. An image forming apparatus comprising:
an image bearing member;
a developing device, including a developer carrying member for carrying a developer, for developing a latent image formed on said image bearing member;
a humidity sensor for detecting a humidity of the developer in contact with the developer in said developing device; and
a controller for controlling an image forming condition on the basis of a detection result of said humidity sensor,
wherein said controller is capable of executing an operation in a mode, for correcting the image forming condition, on the basis of a history of information on the humidity detected by said humidity sensor when a drive time of said developing device from start of image formation is less than a predetermined time.

2. An apparatus according to claim 1, wherein said controller corrects, during execution of the operation in the mode, the image forming condition on the basis of a detection result of said humidity sensor obtained before and after start of drive of said developing device.

3. An apparatus according to claim 1, wherein during execution of the operation in the mode, said controller decreases a correction amount, with a longer drive time of said developing device, of the image forming condition to be corrected on the basis of a detection result of said humidity sensor obtained before start of drive of said developing device.

4. An apparatus according to claim 1, wherein said controller corrects, during execution of the operation in the mode, the image forming condition on the basis of an ambient humidity change of said developing device in a preceding stop period of said developing device and a stop time in the preceding stop period.

5. An apparatus according to claim 3, wherein said controller increases, during execution of the operation in the mode, the correction amount with a larger degree of the humidity change.

6. An apparatus according to claim 4, wherein during the execution of the operation in the mode, said controller changes a correct amount of the image forming condition so that the correct amount is increased with a longer stop time when the stop time is less than a reference value and so that the correct amount is decreased with the longer stop time when the stop time is not less than the reference value.

7. An apparatus according to claim 1, further comprising a detecting portion for detecting ambient temperature/humidity information of said developing device,
wherein said controller obtains the history of the information on the basis of a detection result of said detecting portion.
